(19) United States
(12) Patent Application Publication
(10) Pub. No.: US 2013/0207626 A1
(43) Pub. Date: Aug. 15, 2013

(54) Switching Power Supply Circuit

(71) Applicant: Sanken Electric Co., Ltd., (US)

(72) Inventor: Akiteru Chiba, Saitama (JP)

(73) Assignee: SANKEN ELECTRIC CO., LTD, Niiza-Shi (JP)

(21) Appl. No.: 13/749,759

(22) Filed: Jan. 25, 2013

(30) Foreign Application Priority Data
Feb. 15, 2012 (JP) 2012-030361

(51) Int. Cl. G05F 1/46

(52) U.S. Cl. CPC G05F 1/468
USPC 323/271

(57) ABSTRACT

A switching power supply circuit includes: a reactor that has a main winding and an auxiliary winding having a leakage inductance, which are magnetically coupled with each other and are connected with each other at one ends thereof; a first series circuit, which has an auxiliary switch and a resonance capacitor connected in series, and which is connected in parallel with a direct current power supply via a main switch; a first diode that, which is connected in parallel with the first series circuit via the auxiliary winding; a smoothing capacitor, which is connected in parallel with at least one of the first series circuit and first diode via the main winding; and a control circuit, which alternately turns on and off the main switch and auxiliary switch to thus control an output voltage of the smoothing capacitor to be a predetermined value.

### CROSS-REFERENCE TO RELATED APPLICATION

This application claims priority from Japanese Patent Application No. 2012-030361 filed on Feb. 15, 2012 the entire subject matter of which is incorporated herein by reference.

### TECHNICAL FIELD

This disclosure relates to a switching power supply circuit capable of reducing a switching loss.

### BACKGROUND ART

A step-down switching power supply circuit has been known. FIG. 6 illustrates an example of the step-down switching power supply circuit of the background art. In FIG. 6, a series circuit of a switching element Q10, a reactor L10 and a smoothing capacitor C10 is connected to both terminals of a direct current power supply Vin. Also, a diode D10 as a free-wheeling diode is connected to a connection point of the switching element Q10 and the reactor L10 and to a negative terminal of the direct current power supply Vin.

A control circuit 100 detects an output voltage Vo from the smoothing capacitor C10 and controls an on-off operation of the switching element Q10 so that the output voltage Vo becomes a predetermined value lower than a voltage (input voltage) of the direct current power supply Vin.

In the below, operations of the step-down switching power supply circuit of the background art shown in FIG. 6 will be described. First, when the switching element Q10 is turned on, current flows through a path in order of Vin, Q10, L10, C10, and Vin. Also, the diode D10 is applied with a voltage of the direct current power supply Vin as a reverse voltage. Then, when the switching element Q10 is turned off, the current (free-wheeling current) flows through a path in order of L10, C10, D10, and L10. The current flows in a forward direction with respect to the diode D10.

Also, for example, JP-A-2000-308337 discloses a two-phase DC/DC converter that suppresses reverse recovery current of a free-wheeling diode, as a technology of the background art.

### SUMMARY

However, according to the step-down switching power supply circuit of the background art, when the switching element 10 is again turned on while the forward current is flowing to the diode D10, the high reverse recovery current flows to the diode D10 because the voltage of the direct current power supply Vin is applied as the reverse voltage. Therefore, a switching loss is caused in the switching element Q10 and the diode D10, and a noise is also increased.

In view of the above, this disclosure provides at least a switching power supply circuit capable of reducing a switching loss.

A switching power supply circuit of this disclosure includes: a reactor that has a main winding and an auxiliary winding having a leakage inductance, which are magnetically coupled with each other and are connected with each other at one ends thereof; a first series circuit, which has an auxiliary switch and a resonance capacitor connected in series, and which is connected in parallel with a direct current power supply via a main switch; a first diode that, which is connected in parallel with the first series circuit via the auxiliary winding; a smoothing capacitor, which is connected in parallel with at least one of the first series circuit and first diode via the main winding; and a control circuit, which alternately turns on and off the main switch and auxiliary switch to thus control an output voltage of the smoothing capacitor to be a predetermined value.

According to this disclosure, it is possible to provide the switching power supply circuit capable of reducing the switching loss.

### BRIEF DESCRIPTION OF THE DRAWINGS

The foregoing and additional features and characteristics of this disclosure will become more apparent from the following detailed descriptions considered with the reference to the accompanying drawings, wherein

FIG. 1 illustrates a switching power supply circuit according to a first illustrative embodiment of this disclosure;

FIG. 2 illustrates waveform diagrams illustrating operations of respective units of the switching power supply circuit shown in FIG. 1;

FIG. 3 illustrates a switching power supply circuit according to a second illustrative embodiment of this disclosure;

FIG. 4 illustrates a switching power supply circuit according to a third illustrative embodiment of this disclosure;

FIG. 5 illustrates a switching power supply circuit according to a fourth illustrative embodiment of this disclosure; and

FIG. 6 illustrates an example of a step-down switching power supply circuit of the background art.

### DETAILED DESCRIPTION

Hereinafter, switching power supply circuits of illustrative embodiments of this disclosure will be described with reference to the drawings.

### First Illustrative Embodiment

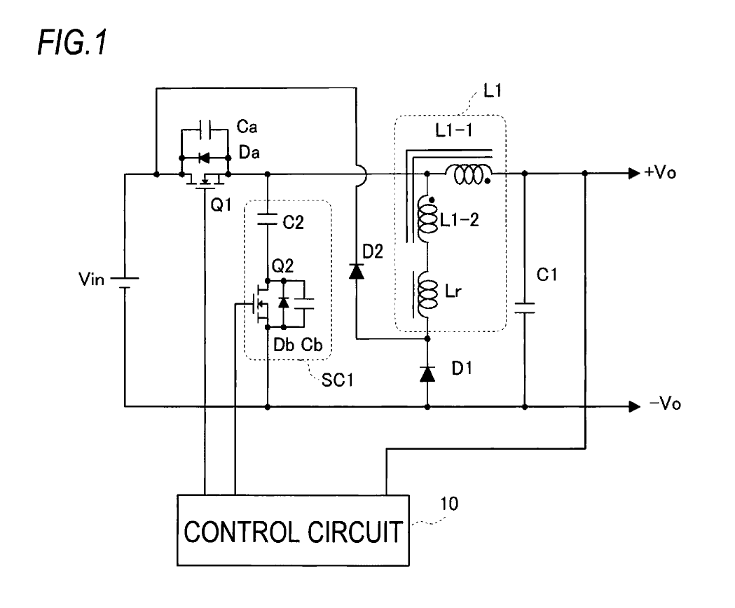

FIG. 1 illustrates a switching power supply circuit according to a first illustrative embodiment of this disclosure. The switching power supply circuit shown in FIG. 1 is a step-down switching power supply circuit that outputs an output voltage Vo having a predetermined value lower than a voltage (input voltage) of a direct current power supply Vin, and has a reactor L1, a switching element Q1, a switching element Q2, a smoothing capacitor C1, a resonance capacitor C2, a diode D1 (first diode), a diode D2 (second diode) and a control circuit 10.

The reactor L1 has a main winding L1-1 and an auxiliary winding L1-2 having a leakage inductance Lr, which are magnetically coupled with each other and are connected with each other at one ends thereof. The leakage inductance Lr is generated so that it is equivalently connected in series with the auxiliary winding L1-2 by winding the main winding L1-1 and auxiliary winding of the reactor L1 in a loose coupling manner.

A first series circuit SC1, in which the switching element Q2 (field effect transistor) and the resonance capacitor C2 are connected in series with each other, is connected to both terminals of the direct current power supply Vin via the switching element Q1 (Field Effect Transistor).

A diode Da and a capacitor Ca are connected between a drain and a source of the switching element Q1. The diode Da may be a parasitic diode of the switching element Q1 and the capacitor Ca may be a parasitic capacitor of the switching element Q1. Also, a diode Db and a capacitor Cb are connected between a drain and a source of the switching element Q2. The diode Db may be a parasitic diode of the switching element Q2 and the capacitor Cb may be a parasitic capacitor of the switching element Q2. The switching element Q1 and diode Da correspond to the main switch of this disclosure and the switching element Q2 and diode Db correspond to the auxiliary switch of this disclosure.

Both ends of the first series circuit SC1 are connected with the diode D1 via the auxiliary winding L1-2 and leakage inductance Lr and connected with the smoothing capacitor C1 via the main winding L1-1.

Also, both terminals of the direct current power supply Vin are connected with the diode D2 via the diode D1. The diode D1 is a free-wheeling diode and the diode D2 is a clamping diode for clamping a cathode potential of the diode D1 to a potential of a positive terminal of the direct current power supply Vin.

The control circuit 10 detects the output voltage Vo from the smoothing capacitor C1 and generates a gate signal Q1g of the switching element Q1 and a gate signal Q2g of the switching element Q2 so that the output voltage Vo becomes a predetermined value lower than a voltage (input voltage) of the direct current power supply Vin and so that turning on of the switching elements Q1, Q2 is to be a zero voltage switching (a switching is made when voltages between the drains and sources of the switching elements Q1, Q2 are substantially zero). The switching elements Q1, Q2 have an off-time period (dead time td) and alternately turn on and off by the gate signals Q1g, Q2g from the control circuit 10.

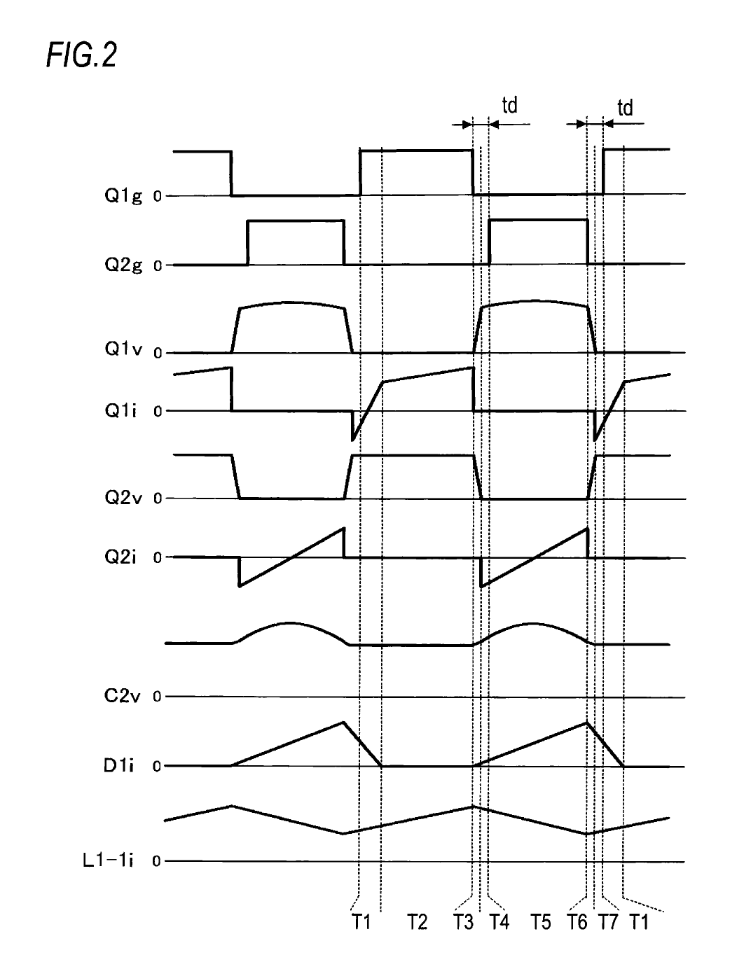

Subsequently, operations of the switching power supply circuit according to the first illustrative embodiment will be described with reference to waveform diagrams (timing charts) shown in FIG. 2.

In FIG. 2, a reference mark Q1g indicates a gate signal that is applied to a gate of the switching element Q1, a reference mark Q2g indicates a gate signal that is applied to a gate of the switching element Q2, a reference mark Q1v indicates a voltage between the drain and source of the switching element Q1, a reference mark Q1i indicates a current between the drain and source of the switching element Q1, a reference mark Q2v indicates a voltage between the drain and source of the switching element Q2, a reference mark Q2i indicates a current between the drain and source of the switching element Q2, a reference mark C2v indicates a voltage between both ends of the resonance capacitor C2, a reference mark D1i indicates a current flowing to the diode D1, and a reference mark L1-1i indicates a current flowing to the main winding L1-1 of the reactor L1. A reference potential point of C2v is a terminal of the resonance capacitor C2, which is not connected to the switching element Q2.

First, in a time period T3, the energy accumulated in the reactor L1 while the switching element Q1 is being on is discharged to the main winding L1-1 and auxiliary winding L1-2, so that the current flows to: a first path in order of L1-1, C1, Vin, Q1(Ca), and L1-1; a second path in order of L1-1, C1, Q2(Cb), C2, and L1-1; and a third path in order of L1-1, C1, D1, Lr, L1-2, and L1-1. The current flowing to the first path charges the capacitor Ca and increases the voltage Q1v. Also, the current flowing to the second path discharges the capacitor Cb and lowers the voltage Q2v. Also, a voltage change rate dCav/dt of the capacitor Ca is based on a time constant of the capacitor Ca and the main winding L1-1 of the reactor L1, and a voltage change rate dCbv/dt of the capacitor Cb is based on a time constant of the capacitor Cb and the main winding L1-1 of the reactor L1. Also, the current flowing to the third path accumulates the energy in the leakage inductance Lr. Additionally, an increase of the current flowing to the third path becomes gentle because of the leakage inductance Lr.

Then, in a time period T4, when the current flowing to the second path discharges (charges in a reverse polarity) the capacitor Cb up to a voltage at which the forward current flows to the diode Db, the current flowing to the second path changes the current path to a fourth path in order of L1-1, C1, Q2(Db), C2, L1-1. That is, the current is commutated from the capacitor Cb to the diode Db. When the switching element Q2 is turned on by the gate signal Q2g while the current flows to the fourth path, it is possible to implement the zero voltage switching of the switching element Q2. Also, the current continues to flow to the third path.

Then, in a time period T5, the resonance capacitor C2 is charged by the current flowing to the fourth path in order of L1-1, C1, Q2(Db), C2, and L1-1 and is discharged by the current flowing to a fifth path in order of C2, Q2, D1, Lr, L1-2, and C2. In the latter half of the time period T5, the resonance capacitor C2 is changed from the charge state to the discharge state by a resonance operation. Also, the current continues to flow to the third path. The fifth path corresponds to the first current path of this disclosure.

Then, in a time period T6, the energy that is charged in the leakage inductance Lr during the time periods T3 to T5 is discharged, so that the current flows to: the third path in order of Lr, L1-2, L1-1, C1, D1, and Lr; a sixth path in order of Lr, L1-2, C2, Q2(Cb), D1, and Lr; and a seventh path in order of Lr, L1-2, Q1(Ca), Vin, D1, and Lr. The current flowing to the sixth path charges the capacitor Cb and increases the voltage Q2v. Also, the current flowing to the seventh path discharges the capacitor Ca and lowers the voltage Q1v.

Then, in a time period T7, when the current flowing to the seventh path discharges (charges in a reverse polarity) the capacitor Ca up to a voltage at which the forward current flows to the diode Da, the current flowing to the seventh path changes the current path to an eighth path in order of Lr, L1-2, Q1(Da), Vin, D1, and Lr. That is, the current is commutated from the capacitor Ca to the diode Da. When the switching element Q1 is turned on by the gate signal Q1g while the current is flowing to the eighth path, it is possible to implement the zero voltage switching of the switching element Q1. Also, the current continues to flow to the third path. The eighth path corresponds to the second current path of this disclosure.

Then, in a time period T1, the current flows to a ninth path in order of Vin, Q1, L1-1, C1, and Vin and the third path. The current of the third path is the forward current of the diode D1 and flows until the discharge of the energy accumulated in the leakage inductance Lr is completed. Also, a difference current between the current L1-1i flowing to the main winding L1-1 and the current flowing to the leakage inductance Lr flows to the switching element Q1.

Then, in a time period T2, since the main winding L1-1 of the reactor L1 is applied with a voltage that is obtained by subtracting the output voltage Vo from the voltage of the direct current power supply Vin, the current L1-1i flowing to the main winding L1-1 is substantially linearly increased. Also, although the diode D1 is applied with the voltage of the direct current power supply Vin as a reverse voltage, the reverse recovery current does not occur because the forward current of the diode D1 becomes zero in the time period T1. In the time period T2, the current flows to the ninth path only, so that the reactor L1 accumulates the energy and the smoothing capacitor C1 is charged to accumulate the energy (electrostatic energy).

As described above, according to the switching power supply circuit of the first illustrative embodiment of this disclosure, the switching element Q1 is turned on by the gate signal Q1g before the leakage inductance Lr completely discharges the energy, i.e., while the forward current is flowing to the diode D1. Since the diode D1 is not applied with the reverse voltage, the reverse recovery current does not occur. Also, when the leakage inductance Lr completely discharges the energy, i.e., when the forward current flowing to the diode D1 becomes zero, the diode D1 is applied with the reverse voltage. Since the current does not flow to the diode D1, the reverse recovery current does not occur. Therefore, it is possible to reduce the switching loss, which is caused due to the reverse recovery current resulting from the reverse recovery characteristic of the diode and to suppress the noise from being generated.

Also, turning on of the switching element Q1, Q2 is to be the zero voltage switching, and when the switching element Q1, Q2, the voltages Q1v, Q2v between the drains and the sources are gently increased is turned off, according to the connection with the capacitors Ca, Cb. Therefore, it is possible to reduce the switching loss of the switching elements Q1, Q2 and to suppress the noise from being generated.

### Second Illustrative Embodiment

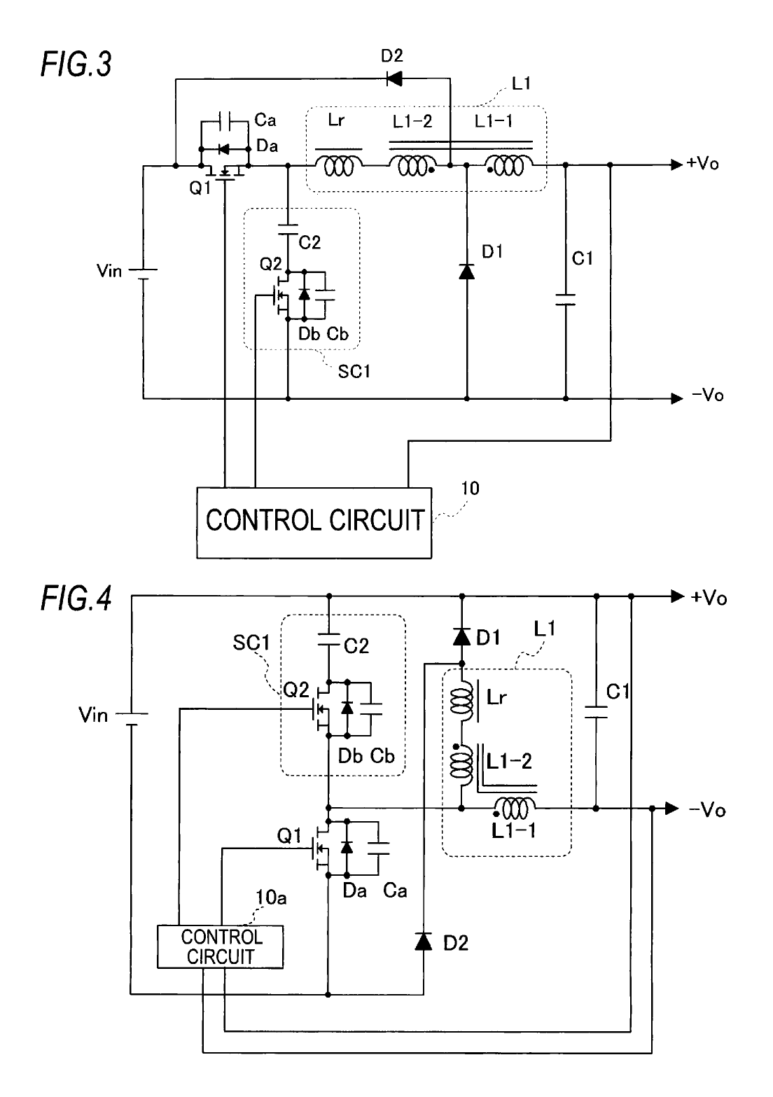

FIG. 3 illustrates a switching power supply circuit according to a second illustrative embodiment of this disclosure. In FIG. 3, the same parts as those of the switching power supply circuit shown in FIG. 1 are indicated with the same reference numerals as those of FIG. 1 and the descriptions thereof are omitted. Although the auxiliary winding L1-2 of the reactor L1 is provided on the current path discharging the resonance capacitor C2 in the switching power supply circuit shown in FIG. 1, auxiliary winding L1-2 of the reactor L1 is provided on a current path charging and discharging the resonance capacitor C2 in the switching power supply circuit shown in FIG. 3.

In FIG. 3, both ends of the first series circuit SC1 are connected with the diode D1 via the auxiliary winding L1-2 and leakage inductance Lr. Also, both ends of the diode D1 are connected with the smoothing capacitor C1 via the main winding L1-1.

Also, both terminals of the direct current power supply Vin are connected with the diode D2 via the diode D1. The diode D1 is a free-wheeling diode, and the diode D2 is a clamping diode for clamping a cathode potential of the diode D1 to a potential of a positive terminal of the direct current power supply Vin.

In the below, operations of the switching power supply circuit according to the second illustrative embodiment will be described with respect to different points from the operations of the switching power supply circuit according to the first illustrative embodiment.

When the switching element Q1 is turned off by the gate signal Q1g and the switching element Q2 is turned on by the gate signal Q2g, the resonance capacitor C2 is charged by the current flowing to a path in order of L1-1, C1, Q2(Db), C2, Lr, L1-2, and L1-1 and is discharged by the current flowing to a path in order of C2, Q2, D1, L1-2, Lr, and C2. In the latter half of the on-period of the switching element Q2, the resonance capacitor C2 is changed from the charge state to the discharge state by a resonance operation.

Then, when the switching element Q2 is turned off by the gate signal Q2g, the energy accumulated in the leakage inductance Lr is discharged. Accordingly, the current flows to a path in order of Lr, Q1(Ca), Vin, D1, L1-2, and Lr and discharges the capacitor Ca to lower the voltage Q1v. Also, the current flows to a path in order of Lr, C2, Q2(Cb), D1, L1-2, and Lr and charges the capacitor Cb to increase the voltage Q2v.

Then, when the voltage Q1v is lowered and the current is thus commutated from the capacitor Ca to the diode Da, the switching element Q1 is turned on by the gate signal Q1g. At this time, since the discharge of the energy accumulated in the leakage inductance Lr is not completed, the reverse voltage has not been applied to the diode D1. Then, when the discharge of the energy accumulated in the leakage inductance Lr is completed, the reverse voltage is applied to the diode D1, so that the current flows to a path in order of Vin, Q1, Lr, L1-2, L1-1, C1, and Vin. Thereby, the reactor L1 accumulates the energy, and the smoothing capacitor C1 is charged to accumulate the energy (electrostatic energy).

Accordingly, even in the switching power supply circuit according to the second illustrative embodiment of this disclosure, it is possible to obtain the same effects as those of the switching power supply circuit according to the first illustrative embodiment of this disclosure.

### Third Illustrative Embodiment

FIG. 4 illustrates a switching power supply circuit according to a third illustrative embodiment of this disclosure. While the switching power supply circuit shown in FIG. 1 has the configuration where the switching element Q1 and the diode D2 are provided at a high side and the switching element Q2 and the diode D1 are provided at a low side, the switching power supply circuit shown in FIG. 4 has a configuration different from that of FIG. 1 in that the switching element Q1 and the diode D2 are provided at a low side and the switching element Q2 and the diode D1 are provided at a high side. Also, a control circuit 10a has a configuration different from that of FIG. 1 in that a differential amplifier (not shown) is provided at an input terminal of the control circuit 10 so as to detect the output voltage Vo from the smoothing capacitor C1. The other configurations are the same as the switching power supply circuit shown in FIG. 1 and the operations thereof can be also easily inferred from the switching power supply circuit shown in FIG. 1. Thus, the descriptions of the operations are here omitted.

Accordingly, even in the switching power supply circuit according to the third illustrative embodiment of this disclosure, it is possible to obtain the same effects as those of the switching power supply circuit according to the first illustrative embodiment of this disclosure.

### Fourth Illustrative Embodiment

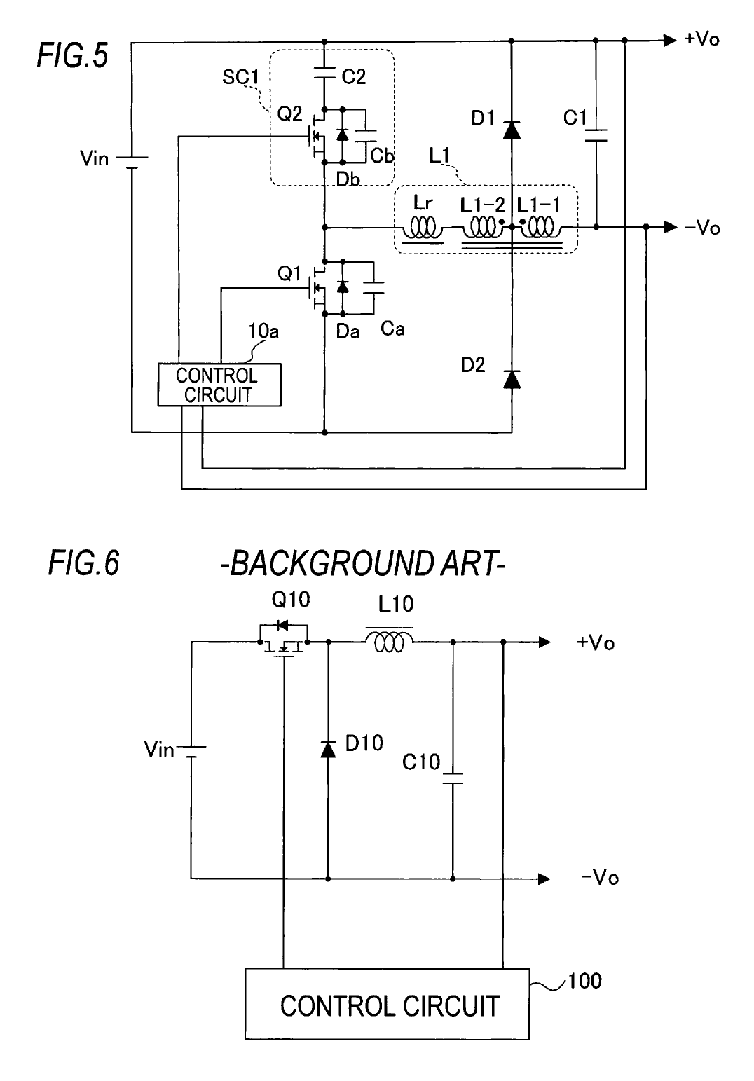

FIG. 5 illustrates a switching power supply circuit according to a fourth illustrative embodiment of this disclosure. While the switching power supply circuit shown in FIG. 3 has the configuration where the switching element Q1 and the diode D2 are provided at the high side and the switching element Q2 and the diode D1 are provided at the low side, the switching power supply circuit shown in FIG. 5 has a configuration different from that of FIG. 3 in that the switching element Q1 and the diode D2 are provided at the low side and the switching element Q2 and the diode D1 are provided at the high side. Also, the control circuit 10a has a configuration different from that of FIG. 3 in that a differential amplifier (not shown) is provided at an input terminal of the control circuit 10 so as to detect the output voltage Vo from the smoothing capacitor C1. The other configurations are the same as the switching power supply circuit shown in FIG. 3 and the operations thereof can be also easily inferred from the switching power supply circuit shown in FIG. 3. Thus, the descriptions of the operations are omitted here.

Accordingly, even in the switching power supply circuit according to the fourth illustrative embodiment of this disclosure, it is possible to obtain the same effects as those of the switching power supply circuit according to the second illustrative embodiment of this disclosure.

Also, this disclosure is not limited to the above illustrative embodiments. In the illustrative embodiments of this disclosure, the reference numeral Lr indicates the inductance (leakage inductance equivalently connected in series with the auxiliary winding L1-2) that is provided integrally with the reactor L1 and the main winding L1-1 and auxiliary winding L1-2 of the reactor L1 are loosely coupled with each other. However, a reactor (first reactor), in which the main winding L1-1 and the auxiliary winding L1-2 are closely coupled, with each other may be also used. In this case, regarding Lr, an independent inductance (second reactor) should be used, not the inductance that is provided integrally with the reactor.

The switching power supply circuit of this disclosure can be applied to a switching power supply device such as non-isolated step-down converter, DC-DC converter, AC-DC converter and the like.

What is claimed is:

1. A switching power supply circuit comprising:
a reactor that has a main winding and an auxiliary winding having a leakage inductance, which are magnetically coupled with each other and are connected with each other at one ends thereof;
a first series circuit, which has an auxiliary switch and a resonance capacitor connected in series, and which is connected in parallel with a direct current power supply via a main switch;
a first diode that, which is connected in parallel with the first series circuit via the auxiliary winding;
a smoothing capacitor, which is connected in parallel with at least one of the first series circuit and first diode via the main winding; and
a control circuit, which alternately turns on and off the main switch and auxiliary switch to thus control an output voltage of the smoothing capacitor to be a predetermined value.

2. The switching power supply circuit according to claim 1, further comprising:
a second diode, which is connected in parallel with the direct current power supply via the first diode,
wherein the second diode clamps a voltage that is applied to the first diode.

3. The switching power supply circuit according to claim 1,
wherein a first current path includes the resonance capacitor, the auxiliary switch, the first diode and the auxiliary winding,
wherein a second current path passing includes the auxiliary winding, the main switch, the direct current power supply and the first diode
wherein the control circuit turns off the auxiliary switch while current is flowing to the first current path, so that the current flows to the second current path passing, and when the current flows to the second current path, the control circuit turns on the main switch.

4. The switching power supply circuit according to claim 1,
wherein the control circuit controls so that turning on of the main switch and the auxiliary switch is to be a zero voltage switching.

5. A switching power supply circuit comprising:
a first reactor that has a main winding and an auxiliary winding which are magnetically coupled with each other and are connected with each other at one ends thereof;
a second reactor, which is with the auxiliary winding in series;
a first series circuit, which has an auxiliary switch and a resonance capacitor connected in series, and which is connected in parallel with a direct current power supply via a main switch;
a first diode that, which is connected in parallel with the first series circuit via the auxiliary winding;
a smoothing capacitor, which is connected in parallel with at least one of the first series circuit and first diode via the main winding; and
a control circuit, which alternately turns on and off the main switch and auxiliary switch to thus control an output voltage of the smoothing capacitor to be a predetermined value.
